(19) United States
(12) Patent Application Publication
(10) Pub. No.: US 2026/0269976 A1
(43) Pub. Date: Sep. 10, 2026

(54) FLEXIBLE SIGNALING TO ENABLE UNEQUAL MODULATION AND MULTIPLE-LAYER TRANSMISSIONS IN WIRELESS COMMUNICATIONS

(71) Applicant: MEDIATEK INC., Hsinchu City (TW)

(72) Inventors: Shengquan HU, San Jose, CA (US); Jianhan LIU, San Jose, CA (US); Thomas Edward PARE, JR., San Jose, CA (US)

(21) Appl. No.: 19/167,731

(22) PCT Filed: Aug. 8, 2024
(86) PCT No.: PCT/CN2024/110670

§ 371 Date: Sep. 22, 2025

Related U.S. Application Data
(60) Provisional application No. 63/518,964, filed on Aug. 11, 2023.

(51) Int. Cl. H04L 1/00

(52) U.S. Cl. CPC H04L 1/0033; H04L 1/0003

(57) ABSTRACT

Various schemes pertaining to flexible signaling to enable unequal modulation and multiple-layer transmissions in wireless communications are described. An apparatus (e.g., station (STA)) generates a physical-layer protocol data unit (PPDU) and performs a transmission of the PPDU with signaling to indicate one or more of: (1) whether the transmission is with an unequal modulation (UEQM) or multiple-layer coding (MLC) with unequal modulation and coding scheme (MCS) levels (UEQ-MCS); (2) whether the transmission is for a single physical-layer convergence procedure (PLCP) service data unit (PSDU) or multiple PSDUs per user; and (3) whether the transmission is with a joint encoding or independent encoding.

### CROSS REFERENCE TO RELATED PATENT APPLICATION

The present disclosure is part of a non-provisional patent application claiming the priority benefit of U.S. Provisional Patent Application No. 63/518,964, filed 11 Aug. 2023, the content of which being incorporated by reference in its entirety.

### TECHNICAL FIELD

The present disclosure is generally related to wireless communications and, more particularly, to techniques pertaining to flexible signaling to enable unequal modulation and multiple-layer transmissions in wireless communications.

### BACKGROUND

Unless otherwise indicated herein, approaches described in this section are not prior art to the claims listed below and are not admitted as prior art by inclusion in this section.

In wireless communications, such as Wi-Fi (or WiFi) and wireless local area networks (WLANs) in accordance with one or more Institute of Electrical and Electronics Engineers (IEEE) 802.11 standards, improvements in Performance and throughput at different signal-to-interference-and-noise ratio (SINR) levels, quality of service (QoS) enhancement, and latency reduction are the key objectives for next-generation Wi-Fi 8 UHR (Ultra High Reliability) systems. Unequal modulation (UEQM) and multiple-layer coding/transmission (MLC) with unequal modulation and coding scheme (UEQ-MCS) have been considered as the potential enabling technologies to achieve Wi-Fi 8 targets. The UEQM can be applied to physical-layer protocol data unit (PPDU) transmission for single physical-layer convergence procedure (PLCP) service data unit (PSDU) per-user with joint encoding. The UEQM can be assigned on either a frequency subblock/resource unit (RU)/multi-RU (MRU) basis or a spatial stream (SS) basis, or both. UEQ-MCS (Unequal MCS levels or MLC) or UEQM can be applied to PPDU transmission for multiple PSDUs per user with independent/separate/individual encoding. The UEQ-MCS can also be scheduled on either a frequency subblock/RU/MRU basis or an SS basis, or both. However, how to enable UEQM or UEQ-MCS transmission for either single PSDU or multiple PSDU per-user with either joint encoding or independent encoding remains to be defined. Therefore, there is a need for a solution of flexible signaling to enable unequal modulation and multiple-layer transmissions in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to flexible signaling to enable unequal modulation and multiple-layer transmissions in wireless communications. Under various proposed schemes described herein, the signaling methods may be based on universal signal field (U-SIG) and/or extremely-high-throughput signal (EHT-SIG) or Trigger Frame formats as specified in IEEE 802.11be. It is believed that implementations of the proposed schemes may address or otherwise alleviate aforementioned issues.

In one aspect, a method may involve generating a PPDU. The method may also involve performing a transmission of the PPDU with signaling to indicate one or more of the following: (1) whether the transmission is with an UEQM or MLC with UEQ-MCS; (2) whether the transmission is for a single PSDU or multiple PSDUs per user; and (3) whether the transmission is with a joint encoding or independent encoding.

In another aspect, an apparatus may include a transceiver and a processor coupled to the transceiver. The transceiver may be configured to transmit and receive wirelessly. The processor may be configured to generate a PPDU. The processor may also perform a transmission of the PPDU with signaling to indicate one or more of the following: (1) whether the transmission is with an UEQM or MLC with UEQ-MCS; (2) whether the transmission is for a single PSDU or multiple PSDUs per user; and (3) whether the transmission is with a joint encoding or independent encoding.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example design under a proposed scheme in accordance with the present disclosure.

FIG. 3 is a diagram of an example design under a proposed scheme in accordance with the present disclosure.

FIG. 4 is a diagram of an example design under a proposed scheme in accordance with the present disclosure.

FIG. 5 is a diagram of an example design under a proposed scheme in accordance with the present disclosure.

FIG. 6 is a diagram of an example design under a proposed scheme in accordance with the present disclosure.

FIG. 7 is a diagram of an example scenario under a proposed scheme in accordance with the present disclosure.

FIG. 8 is a diagram of an example scenario under a proposed scheme in accordance with the present disclosure.

FIG. 9 is a diagram of an example scenario under a proposed scheme in accordance with the present disclosure.

FIG. 10 is a diagram of an example scenario under a proposed scheme in accordance with the present disclosure.

FIG. 11 is a diagram of an example scenario under a proposed scheme in accordance with the present disclosure.

FIG. 12 is a diagram of an example scenario under a proposed scheme in accordance with the present disclosure.

FIG. 13 is a diagram of an example scenario under a proposed scheme in accordance with the present disclosure.

FIG. 14 is a diagram of an example scenario under a proposed scheme in accordance with the present disclosure.

FIG. 15 is a diagram of an example scenario under a proposed scheme in accordance with the present disclosure.

FIG. 16 is a diagram of an example scenario under a proposed scheme in accordance with the present disclosure.

FIG. 17 is a block diagram of an example communication system under a proposed scheme in accordance with the present disclosure.

FIG. 18 is a flowchart of an example process under a proposed scheme in accordance with the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to flexible signaling to enable unequal modulation and multiple-layer transmissions in wireless communications. According to the present disclosure, a number of possible solutions may be implemented separately or jointly. That is, although these possible solutions may be described below separately, two or more of these possible solutions may be implemented in one combination or another.

It is noteworthy that, in the present disclosure, a regular RU (RRU) refers to a RU with tones that are continuous (e.g., immediately adjacent to one another) and not interleaved, interlaced or otherwise distributed. Moreover, a 26-tone regular RU may be interchangeably denoted as RU26 (or RRU26), a 52-tone regular RU may be interchangeably denoted as RU52 (or RRU52), a 106-tone regular RU may be interchangeably denoted as RU106 (or RRU106), a 242-tone regular RU may be interchangeably denoted as RU242 (or RRU242), and so on. Moreover, an aggregate (26+52)-tone regular multi-RU (MRU) may be interchangeably denoted as MRU78 (or RMRU78), an aggregate (26+106)-tone regular MRU may be interchangeably denoted as MRU132 (or RMRU132), and so on. Furthermore, a distributed-tone RU (DRU) refers to a RU with tones that are non-discontinuous (e.g., not immediately adjacent to one another) and interleaved, interlaced or otherwise distributed. Accordingly, a 26-tone distributed-tone RU may be interchangeably denoted as DRU26, a 52-tone distributed-tone RU may be interchangeably denoted as DRU52, a 106-tone distributed-tone RU may be interchangeably denoted as DRU106, a 242-tone distributed-tone RU may be interchangeably denoted as DRU242, a 484-tone distributed-tone RU may be interchangeably denoted as DRU484, a 996-tone distributed-tone RU may be interchangeably denoted as DRU996, a 2×996-tone distributed-tone RU may be interchangeably denoted as DRU2×996, and so on.

It is also noteworthy that, in the present disclosure, a bandwidth of 20 MHz may be interchangeably denoted as BW20 or BW20M, a bandwidth of 40 MHz may be interchangeably denoted as BW40 or BW40M, a bandwidth of 80 MHz may be interchangeably denoted as BW80 or BW80M, a bandwidth of 160 MHz may be interchangeably denoted as BW160 or BW160M, a bandwidth of 240 MHz may be interchangeably denoted as BW240 or BW240M, a bandwidth of 320 MHz may be interchangeably denoted as BW320 or BW320M, a bandwidth of 480 MHz may be interchangeably denoted as BW480 or BW480M, a bandwidth of 500 MHz may be interchangeably denoted as BW500 or BW500M, a bandwidth of 520 MHz may be interchangeably denoted as BW520 or BW520M, a bandwidth of 540 MHz may be interchangeably denoted as BW540 or BW540M, a bandwidth of 640 MHz may be interchangeably denoted as BW640 or BW640M.

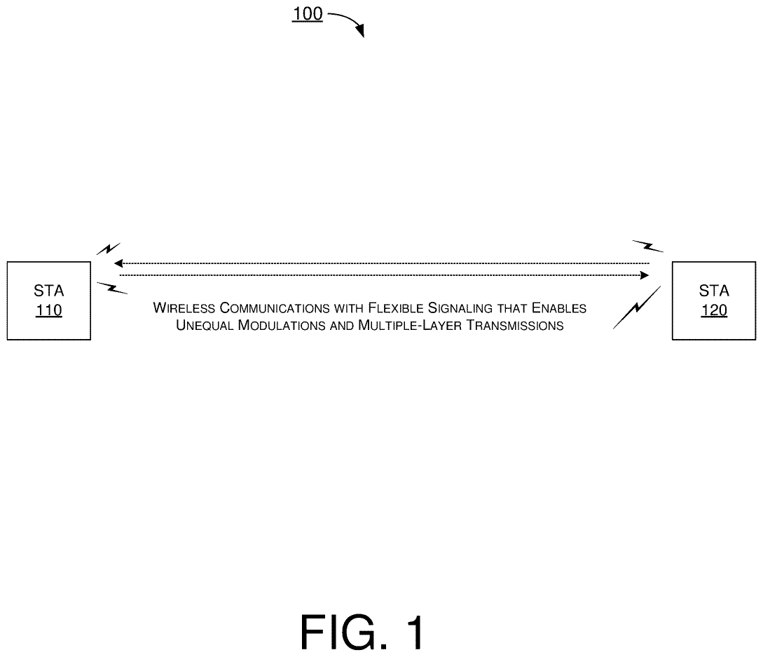

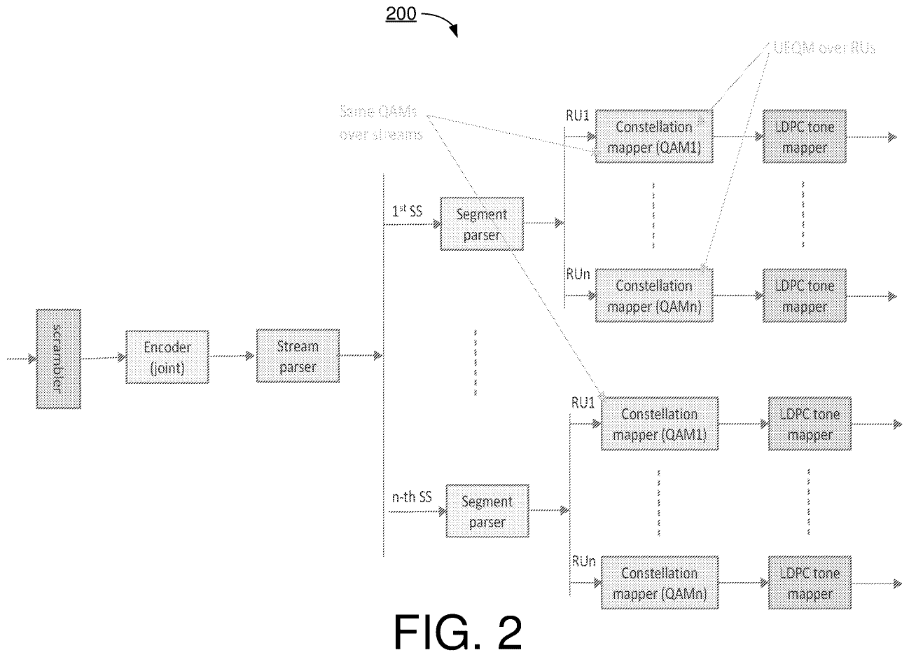

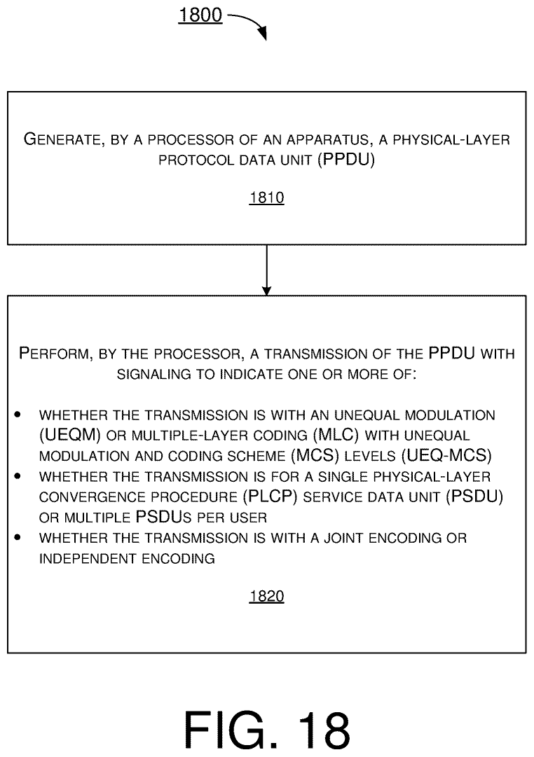

FIG. 1 illustrates an example network environment 100 in which various solutions and schemes in accordance with the present disclosure may be implemented. FIG. 2~FIG. 18 illustrate examples of implementation of various proposed schemes in network environment 100 in accordance with the present disclosure. The following description of various proposed schemes is provided with reference to FIG. 1~FIG. 18.

Referring to FIG. 1, network environment 100 may involve at least a communication entity 110 communicating wirelessly with a communication entity 120. Either of communication entity 110 and communication entity 120 may function as an access point (AP) station (STA) or, alternatively, a non-AP STA. In some cases, communication entity 110 (herein interchangeably referred to as “STA 110”) and communication entity 120 (herein interchangeably referred to as “STA 120”) may be associated with a basic service set (BSS) in accordance with one or more IEEE 802.11 standards (e.g., IEEE 802.11be and/or future-developed standards such as IEEE 802.11bn). Each of communication entity 110 and communication entity 120 may be configured to communicate with each other by utilizing the flexible signaling to enable unequal modulation and multiple-layer transmissions in accordance with various proposed schemes described below. That is, either or both of communication entity 110 and communication entity 120 may function as a “user” in the proposed schemes and examples described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

FIG. 2 illustrates an example design 200 under a proposed scheme in accordance with the present disclosure. Design 200 may pertain to UEQM transmission with joint encoding for single PSDU per user on a RU/MRU basis. Under the proposed scheme, the UEQM may be on a frequency subblock or RU/MRU basis (or frequency-domain basis), with joint encoding for a single PSDU per user. Different RUs may be assigned with different modulations, but with the same coding rate. The UEQM under the proposed scheme may be applied only for large-sized RUs and/or MRUs. The same quadrature amplitude modulation (QAM) may be applied over multiple spatial streams.

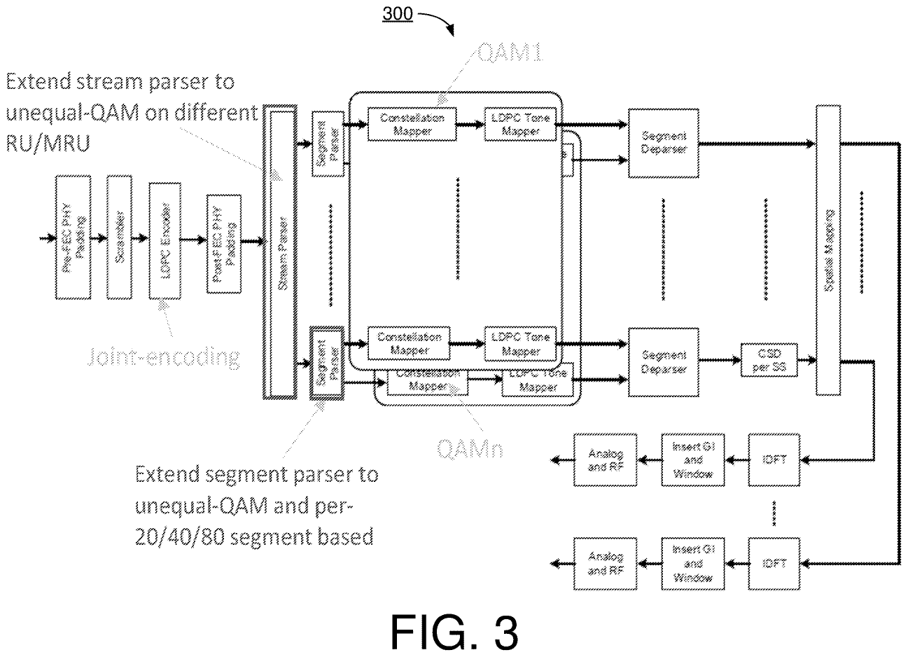

FIG. 3 illustrates an example design 300 under a proposed scheme in accordance with the present disclosure. Design 300 may pertain to UEQM transmission with joint encoding for single PSDU per user on a RU/MRU basis (or frequency-domain basis). Under the proposed scheme, RU/MRU-based UEQM may be operated with the similar processing flow as either EHT single user (EHT-SU) or EHT orthogonal frequency-divisional multiple-access (EHT-OFDMA) with some modifications for some function modules such as stream parser and segment parser as highlighted in FIG. 3. For instance, the stream parser may be extended to unequal QAM on different RUs/MRUs. Moreover, the segment parser may be extended to unequal QAM and on a per-20 MHz/40 MHz/80 MHz-segment basis.

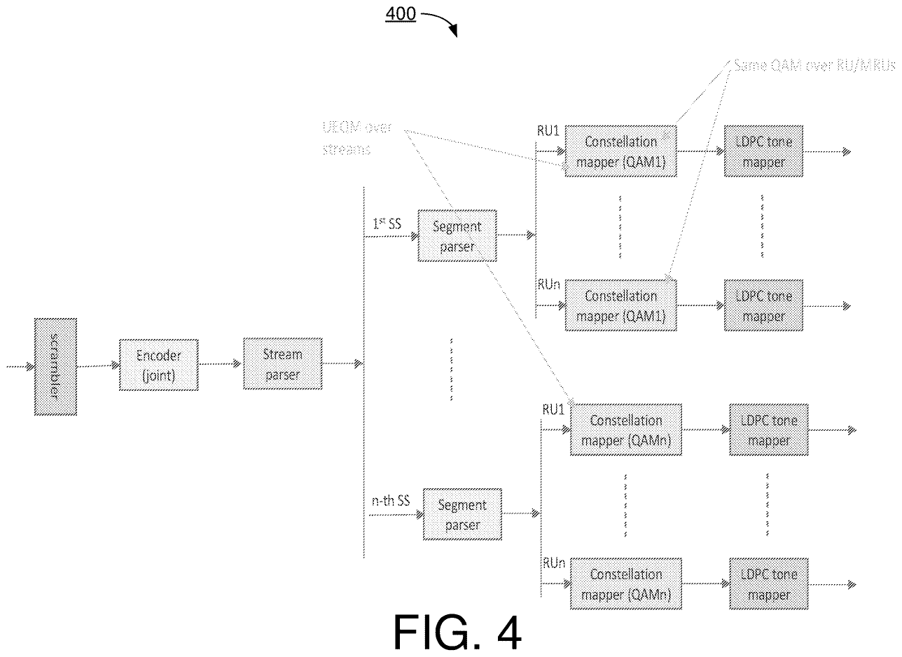

FIG. 4 illustrates an example design 400 under a proposed scheme in accordance with the present disclosure. Design 400 may pertain to UEQM transmission with joint encoding for single PSDU per user on an SS basis (or spatial-domain basis). Under the proposed scheme, the UEQM may be on an SS basis, with joint encoding for a single PSDU per user. Different spatial streams may be assigned with different modulations, but with the same coding rate. The UEQM under the proposed scheme may be applied only for large-sized RUs and/or MRUs. The same QAM may be applied over multiple RUs/MRUs.

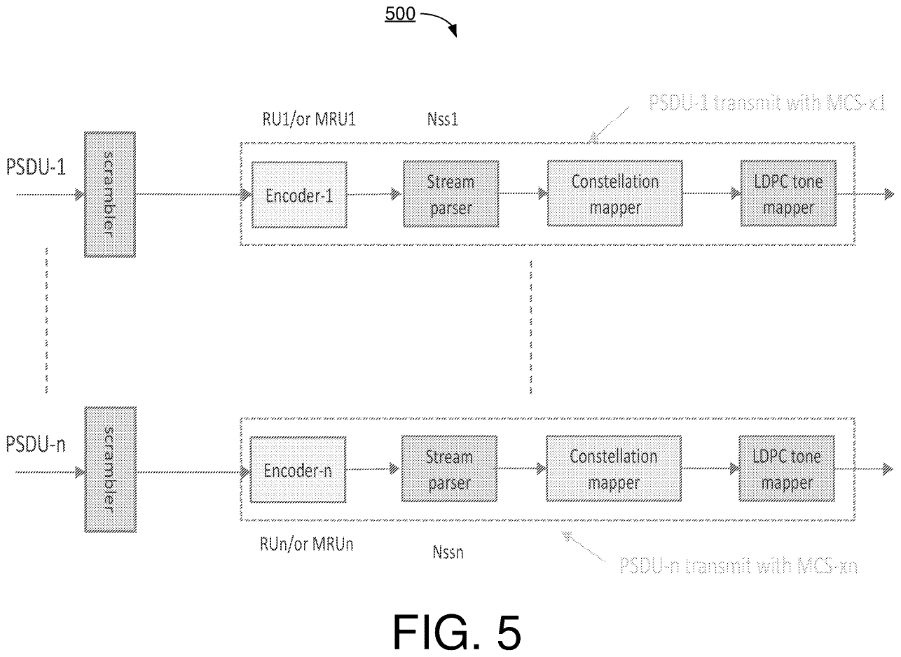

FIG. 5 illustrates an example design 500 under a proposed scheme in accordance with the present disclosure. Design 500 may pertain to UEQ-MCS/UEQM transmission with independent encoding for multiple layers/multiple PSDUs per user on a RU/MRU basis (or frequency-domain basis). Under the proposed scheme, independent or otherwise separate encoding may be applied for each PSDU on each RU or MRU. Different PSDUs on each RU/MRU may be assigned with different modulations or UEQ-MCS. The UEQM or UEQ-MCS may be applied only for large-sized RUs and/or MRUs.

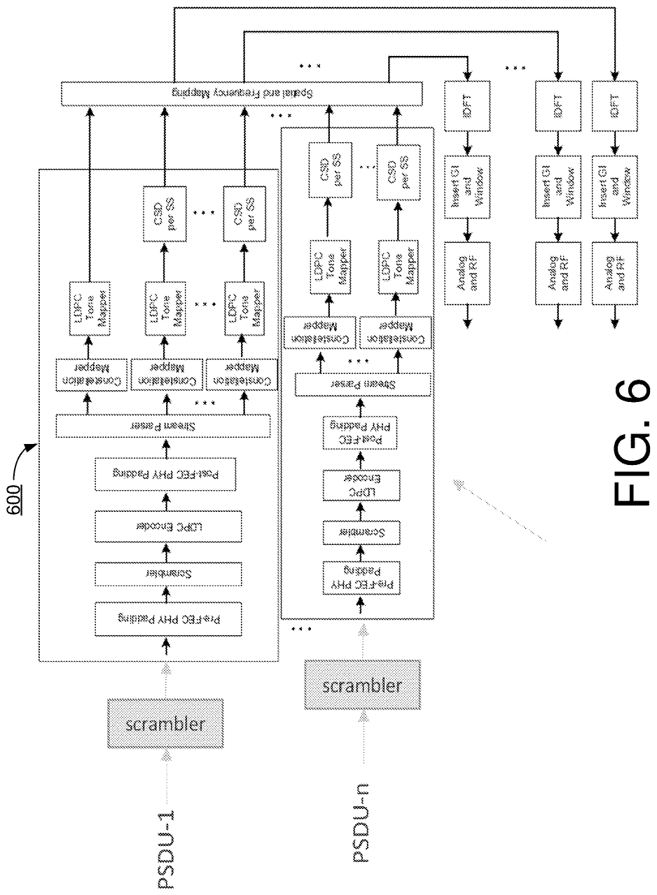

FIG. 6 illustrates an example design 600 under a proposed scheme in accordance with the present disclosure. Design 600 may pertain to UEQ-MCS/UEQM transmission with independent encoding for multiple layers/multiple PSDUs per user on an SS basis (or spatial-domain basis). Under the proposed scheme, independent or otherwise separate encoding may be applied for each PSDU. Each PSDU with different or the same MCS may be scheduled on different spatial streams. The UEQM or UEQ-MCS may be applied only for large-sized RUs and/or MRUs. UEQ-MCS and multi-layer transmission may be operated with the similar processing flow as with multi-user multiple-input-multiple-output (MU-MIMO).

Under various proposed schemes in accordance with the present disclosure with respect to UEQM/UEQ-MCS signaling, each of communication entity 110 and communication entity 120 may be configured to transmit signaling to indicate certain information about a transmission so as to enable UEQM and/or UEQ-MCS transmissions. The indicated information may include, for example and without limitation: (1) whether RU-based or SS-based UEQM/UEQ-MCS transmission; (2) whether joint encoding (single PSDU) or independent encoding (multiple PSDUs); (3) MCS and number of spatial streams (Nₛₛ) on each RU/MRU if RU-based UEQM/UEQ-MCS; (4) MCS and Nₛₛ on each spatial stream if SS-based UEQM/UEQ-MCS; (5) RU/MRU combinations for UEQM/UEQ-MCS; (6) UEQM/UEQ-MCS for SU or OFDMA MU; (7) mixed bandwidths MU-MIMO with UEQM/UEQ-MCS; and (8) UEQM/UEQ-MCS for both downlink (DL) UHR-MU and uplink (UL) trigger-based (TB) PPDU.

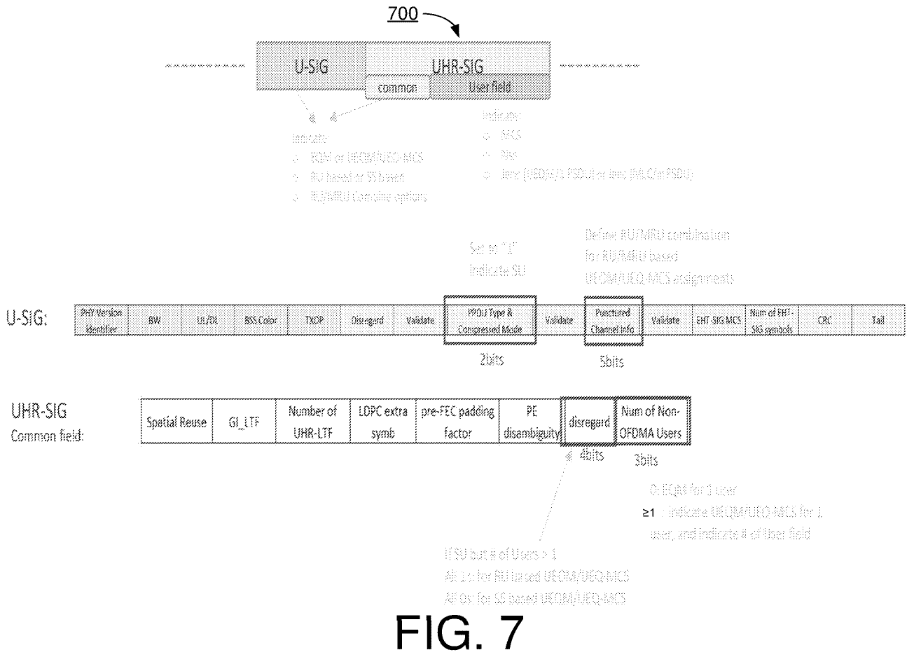

FIG. 7 illustrates an example scenario 700 under a proposed scheme in accordance with the present disclosure. Scenario 700 may pertain to RU/MRU-based (frequency-domain based) UEQM/UEQ-MCS transmissions for a single user (SU) transmission under a first option (Option-1). In scenario 700, signaling under the proposed scheme may be used for both a single PSDU with UEQM and multiple PSDUs (e.g., multiple layers) with UEQ-MCS (e.g., unequal MCS levels). Referring to FIG. 7, the signaling may involve using the U-SIG of a PPDU and/or Common field in the ultra-high reliability signal field (UHR-SIG) of the PPDU to indicate: (1) whether the transmission is with equal modulation (EQM) or with UEQM/UEQ-MCS; (2) whether the transmission is RU/MRU based or SS based; and (3) RU/MRU combination option(s). Moreover, the signaling may also involve using the User field in UHR-SIG to indicate: (1) MCS level; (2) Nₛₛ; and (3) whether joint encoding (Jenc) is utilized (e.g., for UEQM of a single PSDU) or independent encoding (Ienc) is utilized (e.g., for MLC of multiple PSDUs). Referring to FIG. 7, under the proposed scheme, the value of the 2-bit PPDU Type & Compressed Mode subfield in U-SIG may be set to “1” to indicate a single-user (SU) transmission, and the value of the 5-bit Punctured Channel Info subfield in U-SIG may be utilized to define the RU/MRU combination for RU/MRU-based UEQM/UEQ-MCS assignments. Moreover, as shown in FIG. 7, the value of the 4-bit Disregard subfield of the Common field in UHR-SIG may be utilized, in case of SU transmission(s) but the number of users is greater than 1, and set to: (1) all “1s” for RU/MRU-based UEQM/UEQ-MCS; or (2) all “0s” for SS-based UEQM/UEQ-MCS. Furthermore, the value of the 3-bit Number of Non-OFDMA Users subfield of the Common field in UHR-SIG may be set to “0” to indicate EQM for a single user or a value greater than or equal to 1 to indicate UEQM/UEQ-MCS for a single user and also indicate the number of User field.

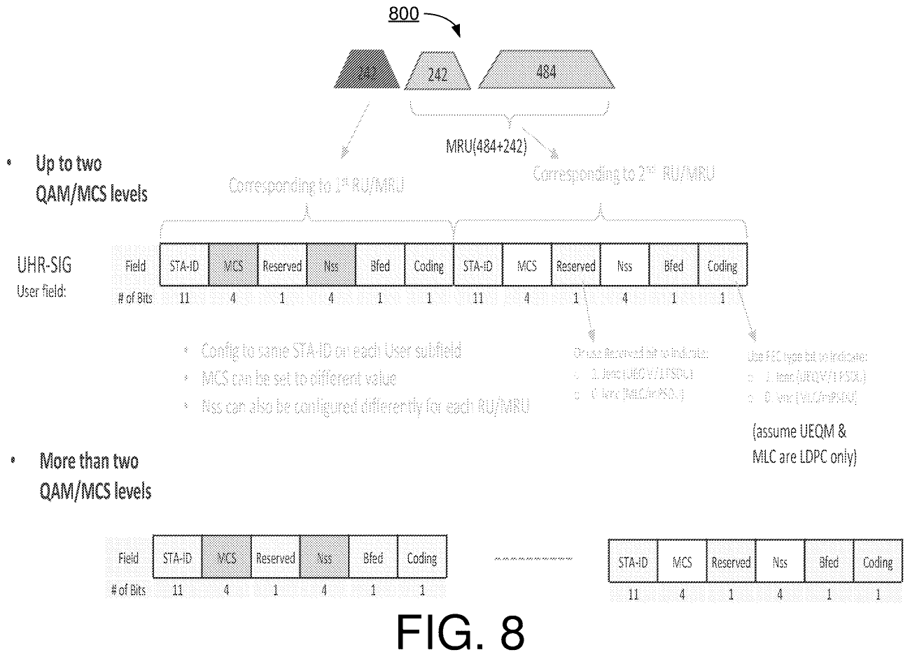

FIG. 8 illustrates an example scenario 800 under a proposed scheme in accordance with the present disclosure. Scenario 800 may pertain to RU/MRU-based (frequency-domain based) UEQM/UEQ-MCS transmissions for a SU transmission under Option-1. Scenario 800 shows an example of signaling for up to two QAM/MCS levels and another example of signaling for more than two QAM/MCS levels. Referring to FIG. 8, the User field of UHR-SIG may be configured with the same STA identifier (STA-ID). Additionally, the value of the MCS subfield may be set to different values for each QAM/MCS level. Moreover, the value of the Nss subfield may be configured differently for each RU/MRU. Under the proposed scheme, the value of the 1-bit Reserved subfield may be set to “1” to indicate Jenc (e.g., e.g., for UEQM of a single PSDU) or “0” to indicate Ienc (e.g., for MLC of multiple PSDUs), or vice versa. Alternatively, or additionally, the value of the 1-bit Coding subfield for forward error correction (FEC) type may be set to “1” to indicate Jenc (e.g., e.g., for UEQM of a single PSDU) or “0” to indicate Ienc (e.g., for MLC of multiple PSDUs), or vice versa.

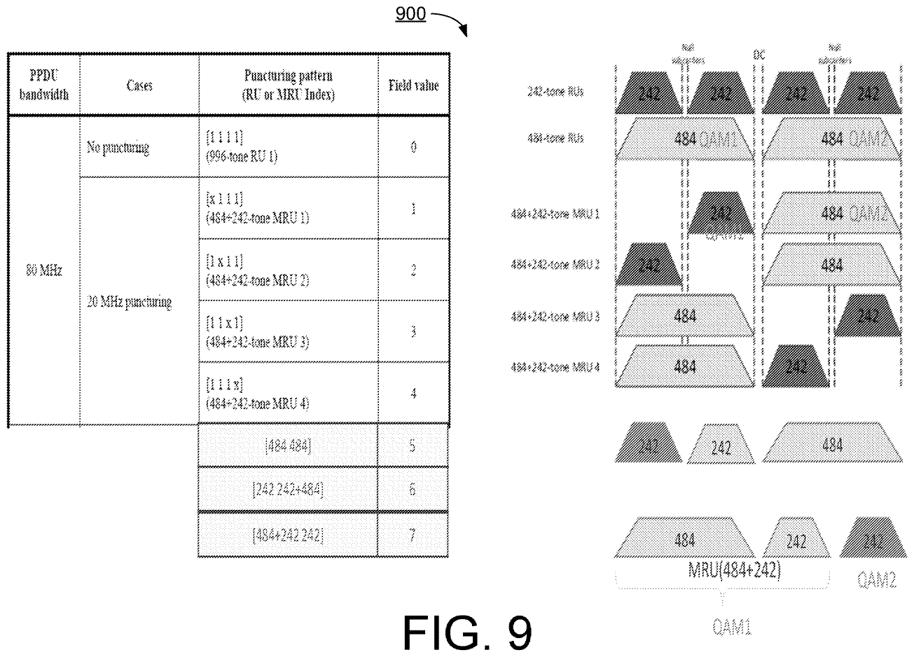

FIG. 9 illustrates an example scenario 900 under a proposed scheme in accordance with the present disclosure. Scenario 900 may pertain to RU/MRU-based (frequency-domain based) UEQM/UEQ-MCS transmissions for a SU transmission under Option-1. Scenario 900 shows an example of RU/MRU combination options for UEQM PPDU transmissions. For instance, one example RU/MRU combination may involve one 484-tone RU (RU484) and another RU484. Another example RU/MRU combination may involve one 242-tone RU (RU242) and an MRU comprising a RU242 and a RU484 (=MRU(242+484)). Yet another example RU/MRU combination may involve an MRU(484+242) plus an RU242.

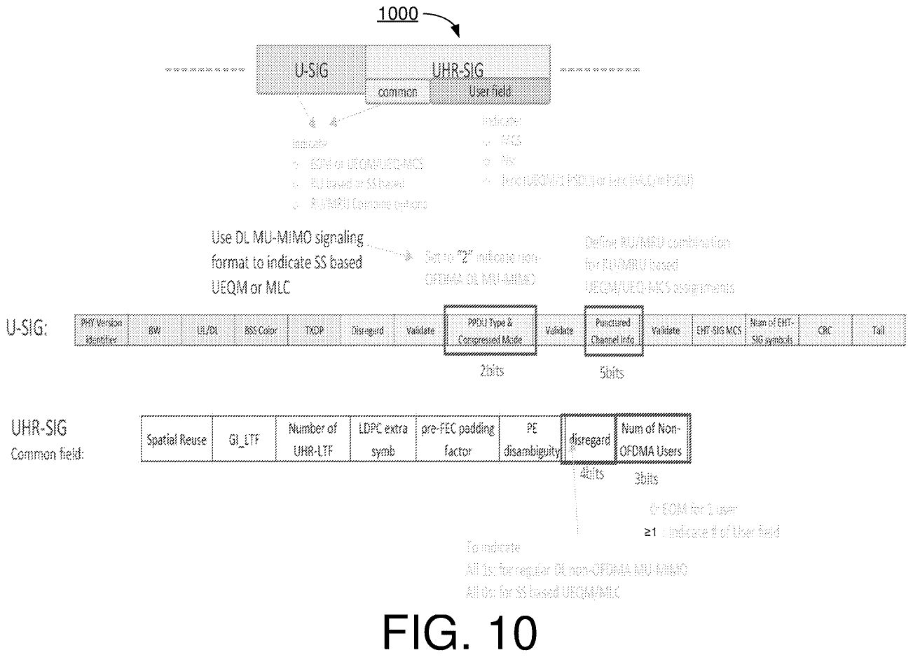

FIG. 10 illustrates an example scenario 1000 under a proposed scheme in accordance with the present disclosure. Scenario 1000 may pertain to SS-based (spatial-domain based) UEQM/UEQ-MCS transmissions for a SU transmission under a second option (Option-2). In scenario 1000, signaling under the proposed scheme may be used for both a single PSDU with UEQM and multiple PSDUs (e.g., multiple layers) with UEQ-MCS (e.g., unequal MCS levels). Referring to FIG. 10, the signaling may involve using the U-SIG of a PPDU and/or Common field in the UHR-SIG of the PPDU to indicate: (1) whether the transmission is with EQM or with UEQM/UEQ-MCS; (2) whether the transmission is RU/MRU based or SS based; and (3) RU/MRU combination option(s). Moreover, the signaling may also involve using the User field in UHR-SIG to indicate: (1) MCS level; (2) Nₛₛ, and (3) whether joint encoding (Jenc) is utilized (e.g., for UEQM of a single PSDU) or independent encoding (Ienc) is utilized (e.g., for MLC of multiple PSDUs). Referring to FIG. 10, under the proposed scheme, the value of the 2-bit PPDU Type & Compressed Mode subfield in U-SIG may be set to “2” to indicate a non-OFDMA DL MU-MIMO transmission. For instance, DL MU-MIMO signaling format may be used to indicate SS-based UEQM or MLC. Additionally, the value of the 5-bit Punctured Channel Info subfield in U-SIG may be utilized to define the RU/MRU combination for RU/MRU-based UEQM/UEQ-MCS assignments. Moreover, as shown in FIG. 10, the value of the 4-bit Disregard subfield of the Common field in UHR-SIG may be utilized and set to: (1) all “1s” for regular DL non-OFDMA MU-MIMO transmission; or (2) all “0s” for SS-based UEQM/UEQ-MCS. Furthermore, the value of the 3-bit Number of Non-OFDMA Users subfield of the Common field in UHR-SIG may be set to “0” to indicate EQM for a single user or a value greater than or equal to 1 to indicate the number of User field.

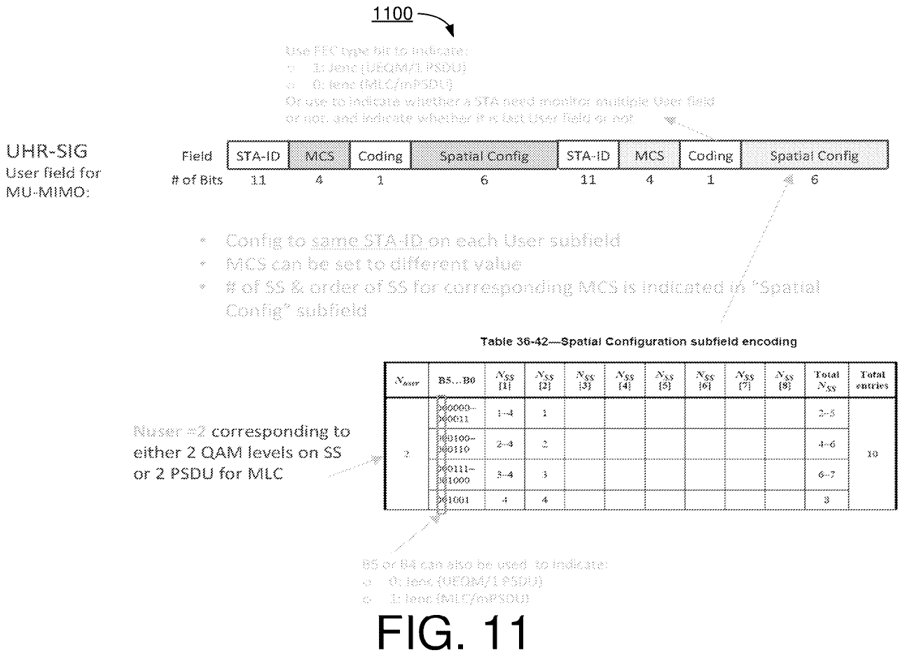

FIG. 11 illustrates an example scenario 1100 under a proposed scheme in accordance with the present disclosure. Scenario 1100 may pertain to SS-based (spatial-domain based) UEQM/UEQ-MCS transmissions for a SU transmission under Option-2. Referring to FIG. 11, the User field of UHR-SIG may be configured with the same STA identifier (STA-ID). Additionally, the value of the MCS subfield may be set to different values. Moreover, the value of the Spatial Config subfield may be set to indicate the number of spatial streams and order of spatial streams for a corresponding MCS level. For instance, Nuser (number of users) =2 may correspond to either two QAM levels on SS or two PSDUs for MLC. Moreover, bit B5 or B4 of the Spatial Config subfield may be used to indicate Jenc or Ienc. Under the proposed scheme, the value of the 1-bit Coding subfield for FEC type may be set to “1” to indicate Jenc (e.g., e.g., for UEQM of a single PSDU) or “0” to indicate Ienc (e.g., for MLC of multiple PSDUs), or vice versa. Alternatively, the Coding subfield may be used to indicate whether a STA needs to monitor multiple User fields and indicate whether the STA corresponds to a last User field.

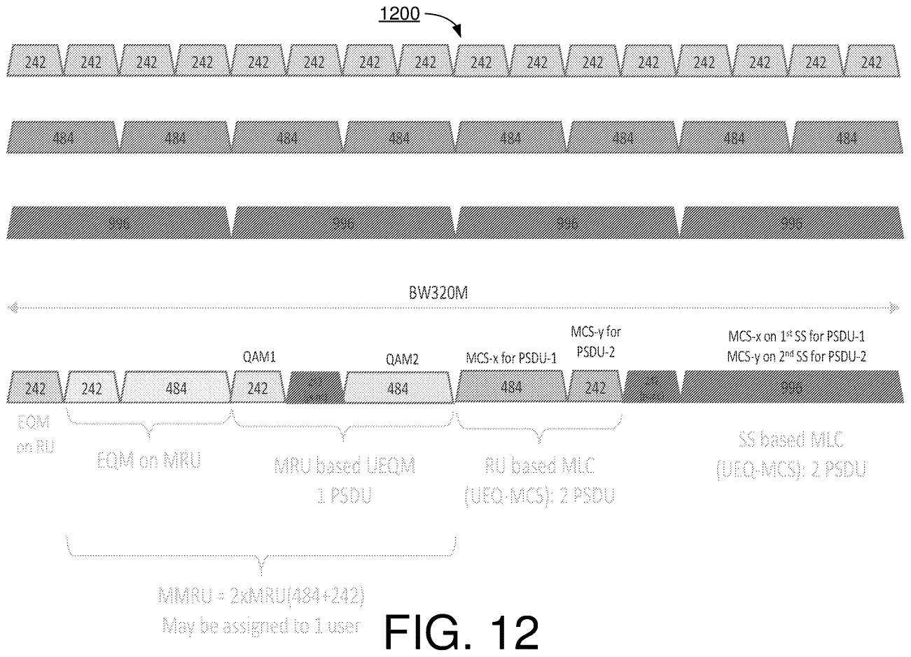

FIG. 12 illustrates an example scenario 1200 under a proposed scheme in accordance with the present disclosure. Scenario 1200 may pertain to an UEQM/UEQ-MCS operation for OFDMA which may be RU/MRU based and SS based. Referring to FIG. 12, for transmission on a wider bandwidth (e.g., 320 MHz or wider), different modulations and/or QAM/MCS levels may be applied to different PSDUs. Moreover, one or more of the PSDUs may be modulated/transmitted on an RU/MRU basis while one or more other PSDUs may be modulated/transmitted on an SS basis.

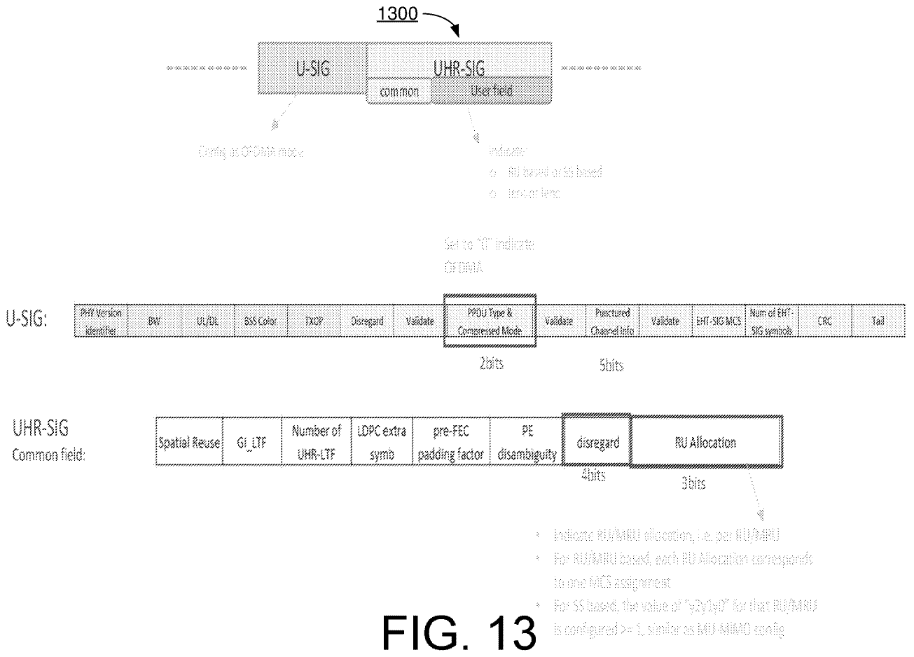

FIG. 13 illustrates an example scenario 1300 under a proposed scheme in accordance with the present disclosure. Scenario 1300 may pertain to RU/MRU-based (frequency-domain based) UEQM/UEQ-MCS transmissions for a DL OFDMA transmission under a third option (Option-3). In scenario 1300, U-SIG may be configured as with an OFDMA mode. Moreover, the User field of UHR-SIG may be utilized to indicate: (1) whether the transmission is RU/MRU based or SS based; and (2) whether joint encoding (Jenc) is utilized (e.g., for UEQM of a single PSDU) or independent encoding (Ienc) is utilized (e.g., for MLC of multiple PSDUs). Additionally, the PPDU Type & Compressed Mode subfield of U-SIG may be set to “0” to indicate OFDMA. Furthermore, the value of the 5-bit RU Allocation subfield of the Common field of UHR-SIG may be set to indicate RU/MRU allocation (e.g., per RU/MRU). In case of RU/MRU-based transmission, each RU Allocation may correspond to one MCS assignment. In case of SS-based transmission, the value of “y2yly0 ” for that RU/MRU may be configured to be greater than or equal to 1, similar to MU-MIMO configuration.

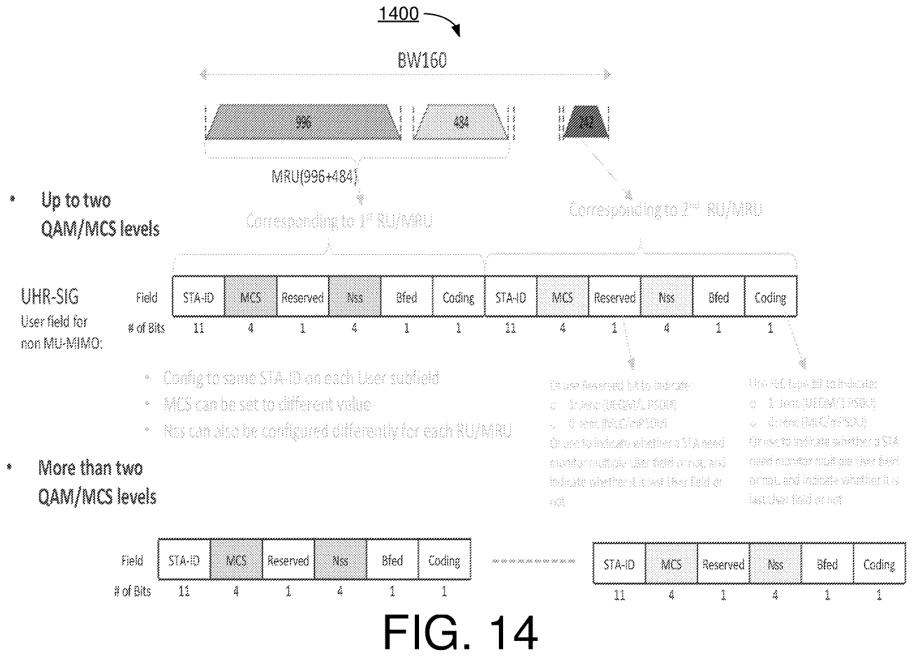

FIG. 14 illustrates an example scenario 1400 under a proposed scheme in accordance with the present disclosure. Scenario 1400 may pertain to RU/MRU-based (frequency-domain based) UEQM/UEQ-MCS transmissions for a DL OFDMA transmission under Option-3. Scenario 1400 shows an example of signaling for up to two QAM/MCS levels and another example of signaling for more than two QAM/MCS levels. Referring to FIG. 14, the User field of UHR-SIG for non-MU-MIMO may be configured with the same STA identifier (STA-ID). Additionally, the value of the MCS subfield may be set to different values for each QAM/MCS level. Moreover, the value of the Nss subfield may be configured differently for each RU/MRU. Under the proposed scheme, the value of the 1-bit Reserved subfield may be set to “1” to indicate Jenc (e.g., e.g., for UEQM of a single PSDU) or “0” to indicate Ienc (e.g., for MLC of multiple PSDUs), or vice versa. Alternatively, the value of the Reserved subfield may be used to indicate whether a STA needs to monitor multiple User fields and also indicate whether the STA corresponds to a last User subfield. Alternatively, or additionally, the value of the 1-bit Coding subfield for FEC type may be set to “1” to indicate Jenc (e.g., e.g., for UEQM of a single PSDU) or “0” to indicate Ienc (e.g., for MLC of multiple PSDUs), or vice versa. Alternatively, the value of the Coding subfield may be used to indicate whether a STA needs to monitor multiple User fields and also indicate whether the STA corresponds to a last User subfield.

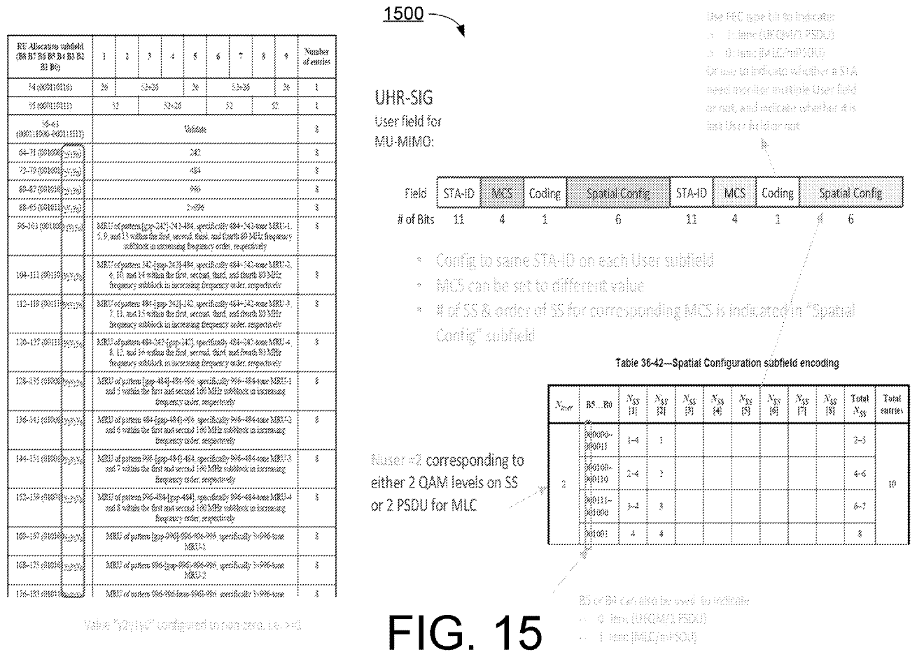

FIG. 15 illustrates an example scenario 1500 under a proposed scheme in accordance with the present disclosure. Scenario 1500 may pertain to SS-based (spatial-domain based) UEQM/UEQ-MCS transmissions for a DL OFDMA transmission under a fourth option (Option-4). Referring to FIG. 15, the User field of UHR-SIG for MU-MIMO may be configured with the same STA identifier (STA-ID). Additionally, the value of the MCS subfield may be set to different values. Moreover, the value of the Spatial Config subfield may be set to indicate the number of spatial streams and order of spatial streams for a corresponding MCS level. For instance, Nuser=2 may correspond to either two QAM levels on SS or two PSDUs for MLC. Moreover, bit B5 or B4 of the Spatial Config subfield may be used to indicate Jenc or Ienc. Under the proposed scheme, the value of the 1-bit Coding subfield for FEC type may be set to “1” to indicate Jenc (e.g., e.g., for UEQM of a single PSDU) or “0” to indicate Ienc (e.g., for MLC of multiple PSDUs), or vice versa. Alternatively, the Coding subfield may be used to indicate whether a STA needs to monitor multiple User fields and indicate whether the STA corresponds to a last User field.

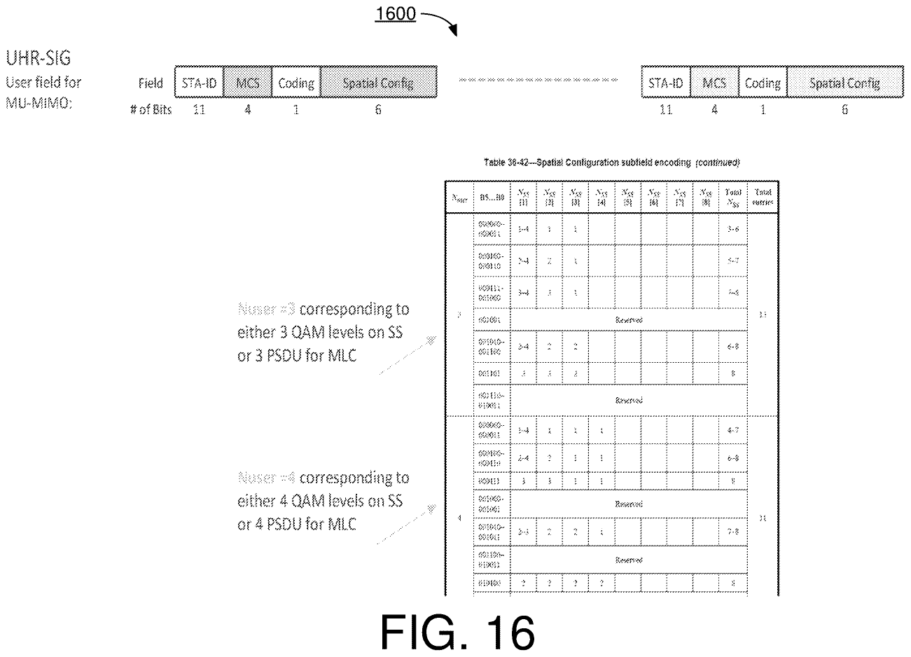

FIG. 16 illustrates an example scenario 1600 under a proposed scheme in accordance with the present disclosure. Scenario 1600 may pertain to SS-based (spatial-domain based) UEQM/UEQ-MCS transmissions for a DL OFDMA transmission under Option-4. In the example shown in FIG. 16, Nuser=3 may correspond to either three QAM levels on SS or three PSDUs for MLC. Moreover, Nuser =4 may correspond to either four QAM levels on SS or four PSDUs for MLC.

### Illustrative Implementations

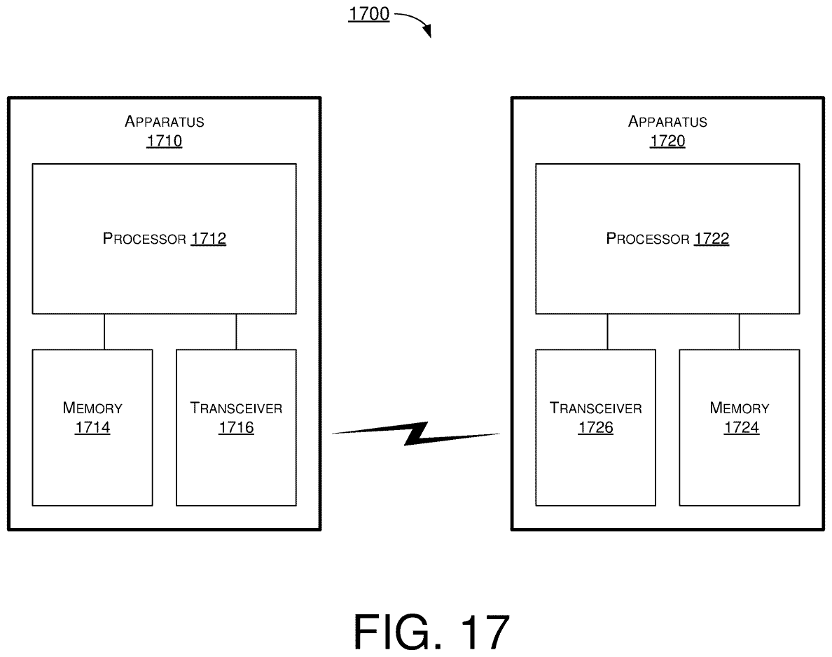

FIG. 17 illustrates an example system 1700 having at least an example apparatus 1710 and an example apparatus 1720 in accordance with an implementation of the present disclosure. Each of apparatus 1710 and apparatus 1720 may perform various functions to implement schemes, techniques, processes and methods described herein pertaining to flexible signaling to enable unequal modulation and multiple-layer transmissions in wireless communications, including the various schemes described above with respect to various proposed designs, concepts, schemes, systems and methods described above as well as processes described below. For instance, apparatus 1710 may be an example implementation of communication entity 110, and apparatus 1720 may be an example implementation of communication entity 120.

Each of apparatus 1710 and apparatus 1720 may be a part of an electronic apparatus, which may be a STA or an AP, such as a portable or mobile apparatus, a wearable apparatus, a wireless communication apparatus or a computing apparatus. For instance, each of apparatus 1710 and apparatus 1720 may be implemented in a smartphone, a smart watch, a personal digital assistant, a digital camera, or a computing equipment such as a tablet computer, a laptop computer or a notebook computer. Each of apparatus 1710 and apparatus 1720 may also be a part of a machine type apparatus, which may be an IoT apparatus such as an immobile or a stationary apparatus, a home apparatus, a wire communication apparatus or a computing apparatus. For instance, each of apparatus 1710 and apparatus 1720 may be implemented in a smart thermostat, a smart fridge, a smart door lock, a wireless speaker or a home control center. When implemented in or as a network apparatus, apparatus 1710 and/or apparatus 1720 may be implemented in a network node, such as an AP in a WLAN.

In some implementations, each of apparatus 1710 and apparatus 1720 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 1710 and apparatus 1720 may be implemented in or as a STA or an AP. Each of apparatus 1710 and apparatus 1720 may include at least some of those components shown in FIG. 17 such as a processor 1712 and a processor 1722, respectively, for example. Each of apparatus 1710 and apparatus 1720 may further include one or more other components not pertinent to the proposed scheme of the present disclosure (e.g., internal power supply, display device and/or user interface device), and, thus, such component(s) of apparatus 1710 and apparatus 1720 are neither shown in FIG. 17 nor described below in the interest of simplicity and brevity.

In one aspect, each of processor 1712 and processor 1722 may be implemented in the form of one or more single-core processors, one or more multi-core processors, one or more RISC processors or one or more CISC processors. That is, even though a singular term “a processor” is used herein to refer to processor 1712 and processor 1722, each of processor 1712 and processor 1722 may include multiple processors in some implementations and a single processor in other implementations in accordance with the present disclosure. In another aspect, each of processor 1712 and processor 1722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1712 and processor 1722 is a special-purpose machine specifically designed, arranged and configured to perform specific tasks including those pertaining to flexible signaling to enable unequal modulation and multiple-layer transmissions in wireless communications in accordance with various implementations of the present disclosure. For instance, each of processor 1712 and processor 1722 may be configured with hardware components, or circuitry, implementing one, some or all of the examples described and illustrated herein.

In some implementations, apparatus 1710 may also include a transceiver 1716 coupled to processor 1712. Transceiver 1716 may be capable of wirelessly transmitting and receiving data. In some implementations, apparatus 1720 may also include a transceiver 1726 coupled to processor 1722. Transceiver 1726 may include a transceiver capable of wirelessly transmitting and receiving data.

In some implementations, apparatus 1710 may further include a memory 1714 coupled to processor 1712 and capable of being accessed by processor 1712 and storing data therein. In some implementations, apparatus 1720 may further include a memory 1724 coupled to processor 1722 and capable of being accessed by processor 1722 and storing data therein. Each of memory 1714 and memory 1724 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1714 and memory 1724 may include a type of read-only memory (ROM) such as mask ROM, programmable ROM (PROM), erasable programmable ROM (EPROM) and/or electrically erasable programmable ROM (EEPROM). Alternatively, or additionally, each of memory 1714 and memory 1724 may include a type of non-volatile random-access memory (NVRAM) such as flash memory, solid-state memory, ferroelectric RAM (FeRAM), magnetoresistive RAM (MRAM) and/or phase-change memory.

Each of apparatus 1710 and apparatus 1720 may be a communication entity capable of communicating with each other using various proposed schemes in accordance with the present disclosure. For illustrative purposes and without limitation, a description of capabilities of apparatus 1710, as communication entity 110, and apparatus 1720, as communication entity 120, is provided below in the context of example process 1800. It is noteworthy that, although the example implementations described below are provided in the context of WLAN, the same may be implemented in other types of networks. Thus, although the following description of example implementations pertains to a scenario in which apparatus 1710 functions as a transmitting device and apparatus 1720 functions as a receiving device, the same is also applicable to another scenario in which apparatus 1710 functions as a receiving device and apparatus 1720 functions as a transmitting device.

### Illustrative Processes

FIG. 18 illustrates an example process 1800 in accordance with an implementation of the present disclosure. Process 1800 may represent an aspect of implementing various proposed designs, concepts, schemes, systems and methods described above. More specifically, process 1800 may represent an aspect of the proposed concepts and schemes pertaining to flexible signaling to enable unequal modulation and multiple-layer transmissions in wireless communications in accordance with the present disclosure. Process 1800 may include one or more operations, actions, or functions as illustrated by one or more of blocks 1810 and 1820. Although illustrated as discrete blocks, various blocks of process 1800 may be divided into additional blocks, combined into fewer blocks, or eliminated, depending on the desired implementation. Moreover, the blocks/sub-blocks of process 1800 may be executed in the order shown in FIG. 18 or, alternatively, in a different order. Furthermore, one or more of the blocks/sub-blocks of process 1800 may be executed repeatedly or iteratively. Process 1800 may be implemented by or in apparatus 1710 and apparatus 1720 as well as any variations thereof. Solely for illustrative purposes and without limiting the scope, process 1800 is described below in the context of apparatus 1710 as communication entity 110 (e.g., a transmitting device whether a STA or an AP) and apparatus 1720 as communication entity 120 (e.g., a receiving device whether a STA or an AP) of a wireless network such as a WLAN in accordance with one or more of IEEE 802.11 standards. Process 1800 may begin at block 1810.

At 1810, process 1800 may involve processor 1712 of apparatus 1710 generating a PPDU. Process 1800 may proceed from 1810 to 1820.

At 1820, process 1800 may involve processor 1712 performing, via transceiver 1716, a transmission of the PPDU (e.g., to apparatus 1720) with signaling to indicate one or more of the following: (1) whether the transmission is with an UEQM or MLC with UEQ-MCS; (2) whether the transmission is for a single PSDU or multiple PSDUs per user; and (3) whether the transmission is with a joint encoding or independent encoding.

In some implementations, the transmission may include a UEQM transmission with joint encoding for the single PSDU per user. In such cases, in performing the transmission, process 1800 may involve processor 1712 performing the UEQM transmission on a RU or MRU basis. Alternatively, in performing the transmission, process 1800 may involve processor 1712 performing the UEQM transmission on an SS basis.

In some implementations, the transmission may include a UEQ-MCS or UEQM transmission with independent encoding for the multiple PSDUs per user. In such cases, in performing the transmission, process 1800 may involve processor 1712 performing the UEQM transmission on a RU or MRU basis. Alternatively, in performing the transmission, process 1800 may involve processor 1712 performing the UEQM transmission on an SS basis.

In some implementations, the signaling may also indicate whether the transmission is RU or MRU based or SS based. In some implementations, the signaling may further indicate an MCS level and a number of spatial streams (Nₛₛ) on: (a) each RU or MRU in an event that the transmission is RU or MRU based with the UEQM or UEQ-MCS; or (b) each spatial stream (SS) in an event that the transmission is SS based with the UEQM or UEQ-MCS. Alternatively, or additionally, the signaling may further indicate a RU or MRU combination for the UEQM or UEQ-MCS. Alternatively, or additionally, the signaling may further indicate the UEQM or UEQ-MCS for a SU transmission or OFDMA MU transmission. Alternatively, or additionally, the signaling may further indicate: (a) a mixed-bandwidths MU-MIMO with the UEQM or UEQ-MCS; and (b) the UEQM or UEQ-MCS for a DL UHR-MU PPDU and an UL TB PPDU.

In some implementations, the signaling may also involve using a universal signal field (U-SIG) of the PPDU to indicate one or more of the following: (10 whether the transmission is with an EQM or the UEQM or UEQ-MCS; (b) whether the transmission is RU or MRU based or SS based; and (c) an RU or MRU combination. In some implementations, a value of a PPDU Type & Compression Mode subfield of the U-SIG may indicate whether the transmission is a SU transmission or MU-MIMO transmission. Alternatively, or additionally, a value of a Punctured Channel Info subfield of the U-SIG may indicate the RU or MRU combination for a RU or MRU-based UEQM or UEQ-MCS transmission.

In some implementations, the signaling may also involve using a Common field in an UHR-SIG of the PPDU to indicate one or more of the following: (a) whether the transmission is with an EQM or the UEQM or UEQ-MCS; (b) whether the transmission is RU or MRU based or SS based; and (c) an RU or MRU combination. In some implementations, a value of a Disregard subfield of the UHR-SIG may indicate whether the transmission is performed on a RU or MRU basis or on an SS basis. Alternatively, or additionally, a value of a Number of Non-OFDMA Users subfield of the UHR-SIG may indicate whether the transmission is with an EQM for a single user or with UEQM or UEQ-MCS for the single user.

In some implementations, the signaling may also involve using a User field in an UHR-SIG of the PPDU to indicate one or more of the following: (a) an MCS level; (b) Nₛₛ, and (c) whether the transmission is with the joint encoding or independent encoding.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
generating, by a processor of an apparatus, a physical-layer protocol data unit (PPDU); and
performing, by the processor, a transmission of the PPDU with signaling to indicate one or more of:
whether the transmission is with an unequal modulation (UEQM) or multiple-layer coding (MLC) with unequal modulation and coding scheme (MCS) levels (UEQ-MCS);
whether the transmission is for a single physical-layer convergence procedure (PLCP) service data unit (PSDU) or multiple PSDUs per user; and
whether the transmission is with a joint encoding or independent encoding.

2. The method of claim 1, wherein the transmission comprises a UEQM transmission with joint encoding for the single PSDU per user.

3. The method of claim 2, wherein the performing of the transmission comprises performing the UEQM transmission on a resource unit (RU) or multi-RU (MRU) basis.

4. The method of claim 2, wherein the performing of the transmission comprises performing the UEQM transmission on a spatial stream (SS) basis.

5. The method of claim 1, wherein the transmission comprises a UEQ-MCS or UEQM transmission with independent encoding for the multiple PSDUs per user.

6. The method of claim 5, wherein the performing of the transmission comprises performing the UEQ-MCS or UEQM transmission on a resource unit (RU) or multi-RU (MRU) basis.

7. The method of claim 5, wherein the performing of the transmission comprises performing the UEQ-MCS or UEQM transmission on a spatial stream (SS) basis.

8. The method of claim 1, wherein the signaling further indicates whether the transmission is resource unit (RU) or multi-RU (MRU) based or spatial stream (SS) based.

9. The method of claim 8, wherein the signaling further indicates an MCS level and a number of spatial streams (Nₛₛ) on:
each RU or MRU in an event that the transmission is RU or MRU based with the UEQM or UEQ-MCS; or
each spatial stream (SS) in an event that the transmission is SS based with the UEQM or UEQ-MCS.

10. The method of claim 8, wherein the signaling further indicates a RU or MRU combination for the UEQM or UEQ-MCS.

11. The method of claim 8, wherein the signaling further indicates the UEQM or UEQ-MCS for a single-user (SU) transmission or orthogonal frequency-division multiple-access (OFDMA) multi-user (MU) transmission.

12. The method of claim 8, wherein the signaling further indicates:
a mixed-bandwidths multi-user multiple-input-multiple-output (MU-MIMO) with the UEQM or UEQ-MCS; and
the UEQM or UEQ-MCS for a downlink (DL) ultra-high-reliability multi-user (UHR-MU) PPDU and an uplink (UL) trigger-based (TB) PPDU.

13. The method of claim 1, wherein the signaling further comprises using a universal signal field (U-SIG) of the PPDU to indicate one or more of:
whether the transmission is with an equal modulation (EQM) or the UEQM or UEQ-MCS;
whether the transmission is resource unit (RU) or multi-RU (MRU) based or spatial stream (SS) based; and
an RU or MRU combination.

14. The method of claim 13, wherein a value of a PPDU Type & Compression Mode subfield of the U-SIG indicates whether the transmission is a single-user (SU) transmission or multi-user multiple-input-multiple-output (MU-MIMO) transmission.

15. The method of claim 13, wherein a value of a Punctured Channel Info subfield of the U-SIG indicates the RU or MRU combination for a RU or MRU-based UEQM or UEQ-MCS transmission.

16. The method of claim 1, wherein the signaling further comprises using a Common field in an ultra-high reliability signal field (UHR-SIG) of the PPDU to indicate one or more of:
whether the transmission is with an equal modulation (EQM) or the UEQM or UEQ-MCS;
whether the transmission is resource unit (RU) or multi-RU (MRU) based or spatial stream (SS) based; and
an RU or MRU combination option.

17. The method of claim 16, wherein a value of a Disregard subfield of the UHR-SIG indicates whether the transmission is performed on a RU or MRU basis or on an SS basis.

18. The method of claim 16, wherein a value of a Number of Non-OFDMA Users subfield of the UHR-SIG indicates whether the transmission is with an equal modulation (EQM) for a single user or with UEQM or UEQ-MCS for the single user.

19. The method of claim 1, wherein the signaling further comprises using a User field in an ultra-high reliability signal field (UHR-SIG) of the PPDU to indicate one or more of:
an MCS level;
a number of spatial streams (Nₛₛ); and
whether the transmission is with the joint encoding or independent encoding.

20. An apparatus, comprising:
a transceiver configured to transmit and receive wirelessly; and
a processor coupled to the transceiver and configured to perform operations comprising:
generating a physical-layer protocol data unit (PPDU); and
performing, via the transceiver, a transmission of the PPDU with signaling to indicate one or more of:
whether the transmission is with an unequal modulation (UEQM) or multiple-layer coding (MLC) with unequal modulation and coding scheme (MCS) levels (UEQ-MCS);
whether the transmission is for a single physical-layer convergence procedure (PLCP) service data unit (PSDU) or multiple PSDUs per user; and
whether the transmission is with a joint encoding or independent encoding.
